(19) United States
(12) Patent Application Publication
(10) Pub. No.: US 2025/0065657 A1
(43) Pub. Date: Feb. 27, 2025

(54) METHOD, PRINTED PRODUCT AND WEAVING PATTERN

(71) Applicant: DRUCK + DESIGN FRANK GEBHART E.K., Unterankenreute (DE)

(72) Inventor: Frank GEBHART, Baienfurt (DE)

(73) Assignee: DRUCK + DESIGN FRANK GEBHART E.K., Unterankenreute (DE)

(21) Appl. No.: 18/928,342

(22) Filed: Oct. 28, 2024

Related U.S. Application Data
(63) Continuation of application No. PCT/EP2023/060818, filed on Apr. 25, 2023.

(30) Foreign Application Priority Data
Apr. 29, 2022 (DE) 10 2022 110 537.7

(51) Int. Cl. B41M 3/00; B41M 5/00

(52) U.S. Cl. CPC B41M 3/00; B41M 5/0041

(57) ABSTRACT

A method for producing a printed product from a thin carrier material using an electronically provided printing file. Two printing regions are printed to form a flat weaving pattern of woven longitudinal and transverse strips crossing at right angles, with a first coordinate direction of the longitudinal strips and a second coordinate direction of the transverse strips which are carrier material strips printed and separated from one another in the strip longitudinal direction. One side of the weaving pattern is visible as a depiction of the image motif that is divided into image portions in the finished weaving pattern. A first printing region serves to provide all the longitudinal strips which extend in the first coordinate direction, wherein an identical spacing on the longitudinal strip is always taken into consideration between two adjacent image portions on the longitudinal strip in the first coordinate direction.

### CROSS REFERENCE TO RELATED APPLICATIONS

This application is a continuation of International Application No. PCT/EP2023/060818 filed Apr. 25, 2023, which designated the United States, and claims the benefit under 35 USC § 119 (a)-(d) of German Application No. 10 2022 110 537.7 filed Apr. 29, 2022, the entireties of which are incorporated herein by reference.

### FIELD OF THE INVENTION

The present invention relates to a method, printed product and weaving pattern.

### BACKGROUND OF THE INVENTION

In the case of a print product on a carrier material such as paper, the print product reproducing a motif or image motif which serves to form a weaving pattern that reproduces the image motif, the problem arises that reproduction of the image motif on the finished weaving pattern is distorted by the weaving.

In the case of print products or in the case of printing methods based on stored data relating to a printed image motif which is used as a basis for the print product, the print product or the properties, thereof, can be produced in a correspondingly adapted manner by the printing method.

With regard to the prior art, mention is made of DE 3539078 A1, US 2021/0155032 A1, Anonymous: ““Flechtbild” Bild als Poster und Kunstdruck von imbild-verlag bestellen. -ARTFLAKES.COM″ [“ ” Woven picture” Order picture as poster and art print from imbild-verlag.-ARTFLAKES. COM″] and Anonymous: “folia 70252-Braiding and Woven Motifs Set, DIN A4, 16 Sheets with 8 Designs, Includes 190 Paper Strips, Creative Activity for Children: Amazon.de: Toys”.

### SUMMARY OF THE INVENTION

It is an object of the present invention to provide a method, a print product and a weaving pattern in an advantageous manner. In particular, it is intended to be possible to provide a print product for, for example, a craft kit for producing a weaving pattern, from which an image motif, such as a photorealistic image, is almost perfectly reproduced after weaving from printed strips.

The present invention is based on a method for producing a print product by a printing method, wherein the print product comprises a thin carrier material, wherein use is made of an electronically provided print file which provides data relating to an image motif. Suitable printing methods are various printing methods that can be used for the method. For example, a digital printing method or any other desired printing method for image generation is suitable for the present method.

For the present method, a print product that can be produced thereby, and a weaving pattern that can be put together from the print product, various materials that can be printed on can be used as carrier material. For example, a, for example, areal comparatively thin medium or material can be used. For example, it is possible to use a carrier material, for example, based on fibers of plant origin, such as a paper fibrous material, or a paper carrier material or a carrier material based on a wood material or a carrier material based on a plastic or a carrier material based on a metal material or a carrier material based on a textile product or a carrier material based on a composite or composite material.

A thickness of the carrier material, the thickness generally being uniform over the areal extent of the carrier material, lies between a fraction of a millimeter and one to two millimeters.

The core of the present invention is that the print file be used to print two print regions on the carrier material, which differ from one another, wherein the two print regions are each formed from the data relating to the image motif and each print region at least partially reproduces the image motif. The print product is produced in such a way that the print product serves to form an areal weaving pattern composed of longitudinal strips and transverse strips which are crossed at right angles and woven, wherein a Cartesian coordinate system having a first coordinate direction, which is a longitudinal direction or a transverse direction, and having a second coordinate direction is used as a basis, wherein the first coordinate direction and the second coordinate direction are at right angles to one another, with a first coordinate direction of the longitudinal strips, which are parallel to one another, and a second coordinate direction of the transverse strips, which are parallel to one another, wherein the longitudinal strips and the transverse strips can be created, from the print product, as printed carrier material strips which are separated from one another in a strip longitudinal direction. A visible side of the finished woven weaving pattern is visible to a person as a reproduction of the image motif used as the basis, wherein the first print region of the print product is produced and wherein the second print region of the print product is produced, such that all the longitudinal strips running in parallel in the first coordinate direction of the weaving pattern are created from the first print region and wherein all the transverse strips running in parallel in the second coordinate direction of the weaving pattern are created from the second print region. The first print region of the print product and the second print region of the print product are designed to be coordinated with one another in such a way that, in the finished weaving pattern, the image motif is completely and correctly reproduced on the visible side of the weaving pattern, wherein the overall image motif is divided into a multiplicity of quadrilateral image sections, wherein the first print region serves to provide all the longitudinal strips, the longitudinal axis of which run in the first coordinate direction. Account is always taken of an identical distance on the longitudinal strip in the first coordinate direction between two adjacent image sections on the longitudinal strip, the distance being dependent on the material thickness of the carrier material. For example, all the longitudinal strips in the first region uniformly have the same distance. The distance is, for example, realized by a strip-like region on the longitudinal strip. The distance is calculated and is, in a longitudinal direction of a considered longitudinal strip, or of all the longitudinal strips, always identical between two adjacent image sections along the longitudinal strip. This relates to the first print region.

For example, the distance that can be specified by the method is dependent on the material thickness of the carrier material and/or on the bending strength of the carrier material. For example, other, for example, technological or mechanical properties of the carrier material additionally or alternatively also determine the value of the distance.

For example, the distance is 0.98 millimeters in the case of a thickness of the paper carrier material of, for example, 0.14 millimeters and a factor of 7, which is multiplied by the thickness value.

For example, the distance on the longitudinal strip lies in the range from 5 to 15 percent of the length of an image section.

The calculated image sections are printed in the longitudinal direction one after the other on the longitudinal strips and on the transverse strips and are present in the case of the print product.

In this way, the problem of an image offset or of image motif offsets at transitions between mutually adjoining edges from one image section to the image section that adjoins it is solved. An image offset and thus a distorted depiction of the image motif occurs otherwise if two identical images with the same image motif were to be printed, the first image were to be cut into parallel longitudinal strips and the second image were to be cut into parallel transverse strips and these strips were then to be interlaced at right angles to one another.

For example, the two print regions differ from one another in terms of size, such as in terms of the longitudinal dimension and/or in terms of the width dimension, and/or in terms of the printed content or in terms of the depiction of the respective print region that can visually be seen by a person.

The overall image motif is divided, for example, into a multiplicity of image sections.

By specifying and producing a multiplicity of pre-calculated image sections, it is possible to correct a possible offset in the subsequent weaving pattern. The offset which is otherwise visible is accounted for in a wrap-around path of two interwoven strip portions composed of the carrier material. The calculation of the offset and a relevant correction by the distances on all the longitudinal strips is based on material factors of the carrier material and/or technological factors of the carrier material, the wrap-around path being taken into account. The material factors and/or the technological factors of the carrier material influence the wrap-around path and thus the offset which is otherwise apparent on the visible side of the weaving pattern when weaving the strips. Technological factors of the carrier material are, for example, mechanical properties of the carrier material when the carrier material is under load.

The wrap-around path is dependent, for example, on the strength or the thickness of the carrier material, for example, on a paper strength or the paper thickness if the carrier material is, for example, a paper carrier material.

The wrap-around path is dependent, for example, on the behavior of the carrier material with regard to deformation behavior, such as during weaving. The wrap-around path is dependent, for example, on the bending strength of the carrier material. The wrap-around path is dependent, for example, on a paper bending strength if the carrier material is, for example, a paper carrier material.

For example, a plurality of quadrilateral sections are specified in defined fashion on a printing side or visible side on a strip, for example, on each strip of the longitudinal and transverse strips. The quadrilateral sections each define, in the correct position, an image section of the overall image motif.

Quadrilateral sections alternatingly alternate on a strip in its longitudinal direction. For example, on a transverse strip, in the first longitudinal direction, a quadrilateral section which in the subsequent weaving pattern is provided by the strip in question, or the transverse strip, is followed by a next quadrilateral section which is provided as visible quadrilateral section of the weaving pattern by a strip perpendicular to the transverse strip, that is to say a longitudinal strip. Then, on the transverse strip there again follows a quadrilateral section which is provided as visible quadrilateral section of the weaving pattern by the transverse strip in the subsequent weaving pattern by the same transverse strip.

This also applies to all further transverse strips.

In the case of all the longitudinal strips, a quadrilateral section as visible quadrilateral section of the subsequent weaving pattern and a visible quadrilateral section, formed by a transverse strip, of the subsequent weaving pattern also alternate alternatingly.

A non-visible quadrilateral section of the subsequent weaving pattern on a strip is, for example, only partially printed, completely printed or not printed.

In the case of partial printing, for example, a central region of the quadrilateral section which is not visible in the weaving pattern is not printed or is printed with a uniform color such as white or is provided with another print which, for example, differs from the image motif. An edge region of the quadrilateral section, for example, an edge region bordering the central region, is, for example, printed according to the image motif present there. In this way, otherwise possible visually noticeable image motif imperfections or blank spaces in the subsequent weaving pattern are precluded at locations between adjacent strips in the subsequent weaving pattern.

Continuous printing of the longitudinal and/or transverse strips, for example, of all image sections based on the image motif, is not precluded.

A longitudinal strip or the longitudinal axis thereof is oriented at right angles to a transverse strip or to the longitudinal axis thereof. For example, all the longitudinal strips are oriented at right angles to the transverse strips, in particular, to all the transverse strips. The respective longitudinal axis of the longitudinal strips is oriented at right angles to the respective longitudinal axis of the transverse strips in relation to the Cartesian coordinate system or the weaving pattern.

For example, the entire visible side of the weaving pattern is formed exclusively by the image sections on the longitudinal strips and by the image sections on the transverse strips, for example, exclusively by image sections on the longitudinal and transverse strips. For example, the regions belonging to the distance between two image sections on the longitudinal strips are not part of the visible part of the weaving pattern.

In the weaving pattern, a two strip system is used as a basis. During the weaving, the longitudinal strips and the transverse strips alternatingly wrap around always only exactly one strip below and then above and so on.

For example, the distance is calculated from the thickness of the carrier material multiplied by a factor, the factor assuming values of between 5.5 and 8.5. The identical distance, which is always taken into account as identical distance on the longitudinal strip in the first coordinate direction between two adjacent image sections on the longitudinal strip, is calculated from a first factor of between 5.5 and 8.5 and the second factor according to the thickness of the carrier material by multiplication of the two factors. In this way, an almost ideal optical outcome of the formed weaving pattern is achieved.

It is, for example, the case that the print regions are created in such a way that the overall image motif in the finished weaving pattern is divided into a multiplicity of quadrilateral image sections, wherein outer sides of the image sections run parallel to the second coordinate direction and further outer sides of the image sections run parallel to the first coordinate direction.

For example, all the image sections which produce the finished weaving pattern are formed by image sections on the longitudinal strips and on the transverse strips. For example, the weaving pattern is formed exclusively by image sections on the longitudinal strips and on the transverse strips.

On the visible side of the subsequent weaving pattern, there are, for example, alternatingly image sections which alternate in the respective coordinate direction and which vary within the range, for example, of tenths of a millimeter in the case of customary paper materials. In this case, all the image sections provided by the longitudinal strips in the weaving pattern are identical to one another in terms of dimensions. In this case, all the image sections provided by the transverse strips in the weaving pattern are identical to one another in terms of dimensions.

For example, all the visible quadrilaterals on the weaving pattern are square or rectangular, with long sides and shorter broad sides. As an alternative, rectangular and square quadrilaterals are formed on the weaving pattern. For example, broad sides of the quadrilaterals on the longitudinal strips adjoin long sides of quadrilaterals on the transverse strips in the finished weaving pattern. Correspondingly, long sides of the quadrilaterals on the longitudinal strips adjoin broad sides of quadrilaterals on the transverse strips in the finished weaving pattern.

For example, a visible quadrilateral of the weaving pattern, the visible quadrilateral being formed by a longitudinal strip, differs in side length from a side length of a quadrilateral which is formed on the weaving pattern by a quadrilateral on a transverse strip. For example, a long side of a quadrilateral on a longitudinal strip runs in the first coordinate direction. For example, a long side of a visible quadrilateral of the weaving pattern, the visible quadrilateral being formed by a longitudinal strip, for example, in the first coordinate direction, is longer than a long side of a quadrilateral which runs in the second coordinate direction and is formed on the weaving pattern by a quadrilateral on a transverse strip.

For example, all the visible quadrilaterals on the weaving pattern which are formed by the longitudinal strips are identical or almost identical to one another.

For example, all the visible quadrilaterals on the weaving pattern which are formed by the transverse strips are identical or almost identical to one another.

For example, all the visible quadrilaterals on the weaving pattern which are formed by the longitudinal strips have a longer long side than the long sides of the quadrilaterals formed by the transverse strips.

For example, all the image sections of the image motif which together produce the image motif are formed by the entirety of all the image sections which are visible in the weaving pattern on the longitudinal strips together with all the image sections which are visible in the weaving pattern on the transverse strips. For example, the entire visible weaving pattern is formed exclusively by the entirety of all the image sections on the longitudinal strips and on the transverse strips. In other words, regions on the longitudinal strips and on the transverse strips that are present between the sections which are directed outward on the visible side in the weaving pattern are not visible on the visible side in the finished weaving pattern, in particular, are concealed by another strip.

Mutually facing longitudinal edges of two adjacent longitudinal strips are, for example, formed adjoining one another. Mutually facing longitudinal edges of two adjacent longitudinal strips are, for example, formed directly adjoining one another. The longitudinal strips having mutually facing longitudinal edges extending in the first coordinate direction are, for example, formed directly adjoining one another. This relates to the first print region. For example, in the first print region, there is an infinitesimally small thickness of a separating line in the strip longitudinal direction or in the first coordinate direction of the longitudinal strips or in the longitudinal direction of the longitudinal strips between two adjacent longitudinal strips.

For example, in the associated first print region, a dimension of the print region in the second coordinate direction, for example, a width dimension, is not changed in relation to a width dimension of the image motif used as the basis. For example, in the associated first print region, a dimension of the print region in the second coordinate direction, is, for example, a width dimension with a comparatively small oversize in relation to a width dimension of the image motif used as the basis. The comparatively small oversize of the first print region in the second coordinate direction, the first print region forming the longitudinal strips, is, for example, specified by electronic image processing of the first print region. The comparatively small oversize of the first print region in the second coordinate direction is, for example, dependent on an overall width of the image motif in this direction. The comparatively small oversize of the first print region and the second coordinate direction is, for example, between 0.06% and 0.33%. For example, the oversize of the first print region in the second coordinate direction is between 0.1 and 0.5 millimeters in the case of an image motif width of 15.5 centimeters.

For example, an intermediate strip formed by the carrier material of the second print region is formed between two transverse strips in the first coordinate direction. The intermediate strip is not printed, is partially printed or is completely printed. In the second print region, a respective identical distance is thus realized by the intermediate strip, for example, between all the adjacent transverse strips. The intermediate strip is, for example, printed as a printed overfilling means, in order to, for example, compensate for production differences. The respective, for example, identical width of the intermediate strips, which run in parallel between two adjacent transverse strips, is, for example, between 10 and 40 percent of a width of a transverse strip, the width being transverse to the longitudinal extent of the transverse strip or in the first coordinate direction.

Accordingly, the two transverse strips are, for example, formed spaced apart from one another in the first coordinate direction by the intermediate strip. The spacing is, for example, in accordance with the width of the intermediate strip in the first coordinate direction. The distance is, for example, useful for more easily separating the transverse strips from the second print region, for example, with scissors, and/or for the subsequent process of weaving the longitudinal strips with the transverse strips to form the weaving pattern.

Advantageously, a region on a longitudinal strip or a region on a transverse strip, the region not being reproduced on the visible side of the weaving pattern, is not printed or is at least partially not printed or is not printed according to the image motif.

The region which is not reproduced on the visible side of the weaving pattern is, for example, printed white or printed with another color which stands out from adjoining portions.

The present invention extends to a print product composed of a printed carrier material, wherein the print product is produced by a printing method on the basis of data relating to an image motif, wherein the print product has two print regions on the carrier material, which differ from one another, wherein the two print regions are each formed from the data relating to the image motif and each print region at least partially reproduces the image motif, wherein the print product serves to form an areal weaving pattern composed of longitudinal strips and transverse strips which are crossed at right angles and woven, with a first coordinate direction of the longitudinal strips, which are parallel to one another, and a second coordinate direction of the transverse strips, which are parallel to one another, wherein the longitudinal strips and the transverse strips can be created, from the print product, as printed carrier material strips which are separated from one another in the strip longitudinal direction, wherein a visible side of the finished woven weaving pattern is visible to a person as a reproduction of the image motif used as the basis, wherein all the longitudinal strips running in parallel in the first coordinate direction of the weaving pattern can be created from the first print region and wherein all the transverse strips running in parallel in the second coordinate direction of the weaving pattern can be created from the second print region, wherein the first print region of the print product and the second print region of the print product are designed to be coordinated with one another in such a way that, in the finished weaving pattern, the image motif is completely and correctly reproduced on the visible side of the weaving pattern, wherein the overall image motif is divided into a multiplicity of quadrilateral image sections, wherein the first print region serves to provide all the longitudinal strips, the longitudinal axis of which run in the first coordinate direction, wherein account is always taken of an identical distance on the longitudinal strip in the first coordinate direction between two adjacent image sections on the longitudinal strip, the distance being dependent on the material thickness of the carrier material.

The print product is, for example, produced by a digital printing method. The print product is, for example, printed or produced by one of the methods described above.

This forms the foundation for producing a weaving pattern from the longitudinal strips and from the transverse strips, an ideal reproduction of the weaving pattern used as the basis being possible. For example, the print product serves as starting product for a craft kit for the manual pastime by handicraft in creating a weaving pattern composed of crossed and woven printed strips.

The two print regions, for example, have carrier material regions which adjoin the strips on the longitudinal end side and/or transverse end side. This serves, for example, for fixing the strips and the print region on a sheet of the carrier material and for better handling when producing the weaving pattern.

For example, the print product has a first printed print region and a second printed print region on the carrier material, which differ from one another, wherein the two print regions are based on a common image motif, wherein longitudinal strips composed of the carrier material can be provided from the first print region and wherein transverse strips composed of the carrier material can be provided from the second print region, such that an areal weaving pattern composed of longitudinal strips and transverse strips which are crossed at right angles and woven can be formed from the longitudinal strips and from the transverse strips of the print product, wherein, in the finished weaving pattern, the image motif is completely and correctly reproduced on the visible side of the weaving pattern.

For example, the longitudinal strips among one another are parallel to the first coordinate direction. For example, the transverse strips among one another are parallel to the second coordinate direction.

It is, for example, also the case that the longitudinal strips have opposite parallel longitudinal edges which are separated from adjoining regions of the print product.

The opposite parallel longitudinal edges of the longitudinal strips are, for example, cut free. The opposite parallel longitudinal edges of the longitudinal strips are, for example, prepared in such a way that the longitudinal strips are cut free along their length on both sides in the longitudinal direction from a region of the carrier material that extends toward them, for example, from adjacent edges of an adjacent longitudinal strip.

For example, the transverse strips have opposite parallel longitudinal edges which are separated from adjoining regions of the print product.

The opposite parallel longitudinal edges of the transverse strips are, for example, cut free. The opposite parallel longitudinal edges of the transverse strips are, for example, prepared in such a way that the transverse strips are cut free along their length on both sides in the longitudinal direction from a region of the carrier material that extends toward them, for example, from adjacent edges of an adjacent intermediate strip. For example, in the case of all the transverse strips, an intermediate strip is present between two adjacent transverse strips. For example, all the intermediate strips between two adjacent transverse strips in the second print region have the same strip width among one another.

For example, an end-side end of the longitudinal strip is connected to a region of the print product that adjoins a longitudinal strip. The region of the print product is, for example, formed by carrier material.

For example, the two opposite longitudinal ends of the longitudinal strips are connected to the adjoining region of the print product.

For example, the longitudinal strips in the first print region each remain connected at the end side to the surrounding carrier material.

For example, the two longitudinal ends of a longitudinal strip, for example, all the longitudinal strips, are connected to the carrier material and each longitudinal strip is cut free along its entire length on both sides from the carrier material.

This facilitates the creation of the weaving pattern and the handling of the print product.

For example, an end-side end of the transverse strip is connected to a region of the print product that adjoins a transverse strip. The region of the print product is for example formed by carrier material.

This provides an advantageous structure for the subsequent weaving pattern.

For example, the two longitudinal ends of a transverse strip, for example, all the transverse strips, are connected to the carrier material and each transverse strip is cut free along its entire length on both sides from the carrier material.

To produce the weaving pattern, for example, only the transverse strips are also separated at both end sides from the carrier material surrounding the second print region, and the obtained transverse strips are woven through the parallel longitudinal strips that are next to one another.

For example, in the extension of an end-side end of a longitudinal strip and/or in the extension of an end-side end of a transverse strip, a marking is present which enables visual identifiable assignment of the respective longitudinal strip or transverse strip with respect to its position in the first coordinate direction and/or second coordinate direction. This facilitates the subsequent production of the weaving pattern.

It is, for example, also the case that information is printed outside the region of the longitudinal strip and/or outside the region of the transverse strip.

The information serves, for example, to assist handling for creation of the weaving pattern, for example, by means of line numbers for the respective transverse strip and/or longitudinal strip and/or a color marking for differentiation or assignment of the longitudinal or transverse strips in the weaving pattern.

Lastly, a weaving pattern composed of strips of a carrier material is proposed, wherein the areal weaving pattern is formed from longitudinal strips and transverse strips which are crossed at right angles and woven, with a first coordinate direction of the longitudinal strips, which are parallel to one another, and a second coordinate direction of the transverse strips, which are parallel to one another, wherein the longitudinal strips and the transverse strips are created, from a print product, as printed carrier material strips which are separated from one another in the strip longitudinal direction, wherein a visible side of the finished woven weaving pattern is visible to a person as a reproduction of an image motif used as the basis, wherein the print product has a first print region from which all the longitudinal strips running in parallel in the first coordinate direction of the weaving pattern can be created and wherein the print product has a second print region from which all the transverse strips running in parallel in the second coordinate direction of the weaving pattern can be created, wherein the first print region of the print product and the second print region of the print product are designed to be coordinated with one another in such a way that, in the finished weaving pattern, the image motif is completely and correctly reproduced on the visible side of the weaving pattern, wherein the overall image motif is divided into a multiplicity of quadrilateral image sections, wherein the first print region serves to provide all the longitudinal strips, the longitudinal axis of which run in the first coordinate direction, wherein account is always taken of an identical distance on the longitudinal strip in the first coordinate direction between two adjacent image sections on the longitudinal strip, the distance being dependent on the material thickness of the carrier material.

The weaving pattern almost perfectly reproduces the image motif used as the basis.

For example, the two print regions are each formed from the data relating to the image motif and each print region reproduces image sections of the image motif.

For example, a frame-like border of the weaving pattern is provided, the border adjoining longitudinal ends of the longitudinal strips and longitudinal ends of the transverse strips. This achieves an esthetically pleasing overall impression of the finished weaving pattern.

### BRIEF DESCRIPTION OF THE DRAWINGS

Further features and advantages of the present invention will be explained in more detail on the basis of exemplary embodiments.

FIG. 1 shows a first print region of a print product;

FIG. 2 shows a second print region of the print product; and

FIG. 3 shows a weaving pattern formed from the print regions according to FIG. 1 and FIG. 2.

### DETAILED DESCRIPTION OF THE INVENTION

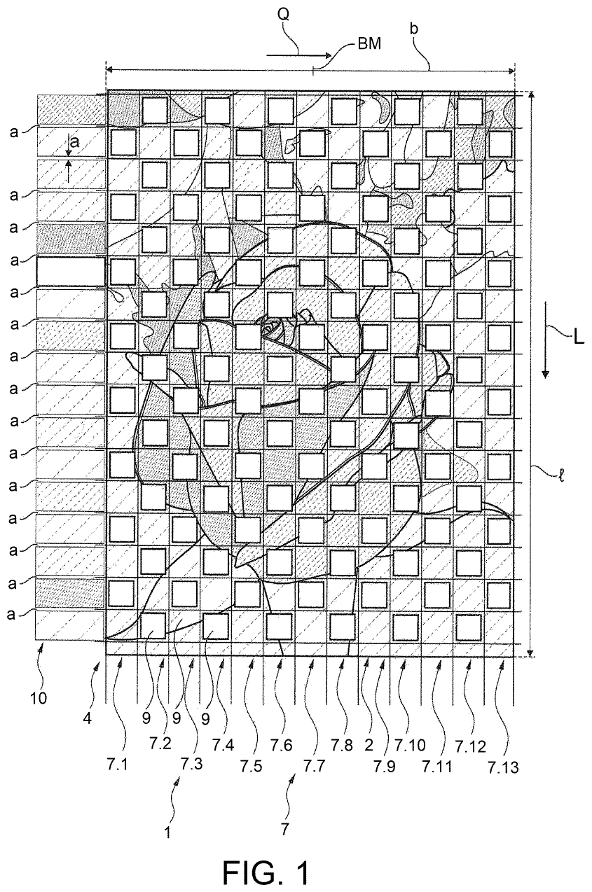

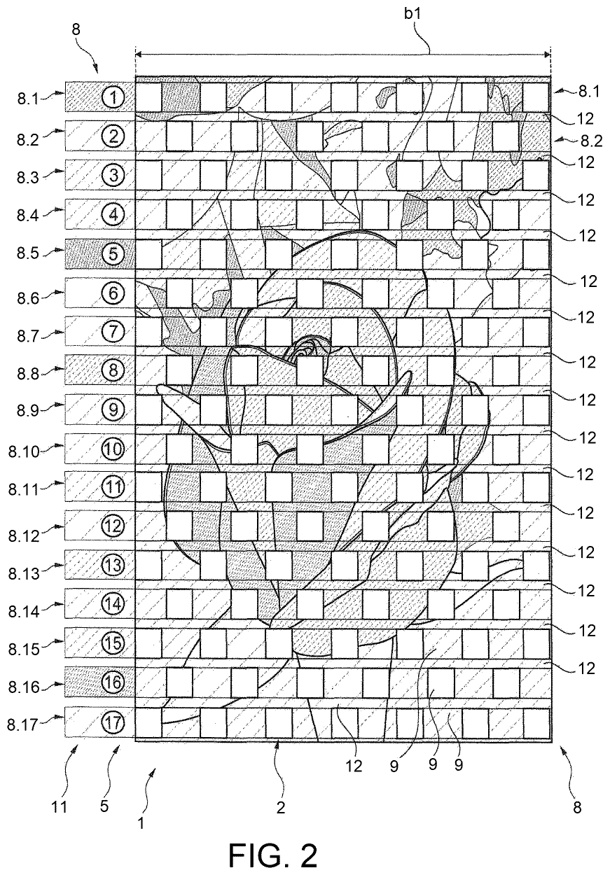

FIGS. 1 and 2 show a print product 1 produced by a printing method, wherein the print product 1 comprises a thin carrier material 2, wherein use is made of an electronically provided print file which provides data relating to an image motif 3.

The print product 1 comprises two print regions, a first print region 4 and a second print region 5, which are formed by printed regions of the carrier material 2.

The two print regions 4 and 5 differ from one another in terms of size or in terms of the dimensions and in terms of the printed content. The two print regions 4, 5 are each formed from the data relating to the image motif 3. Each of the two print regions 4 and 5 partially reproduces the image motif 3, in a multiplicity of quadrilateral sections or image sections of the image motif 3.

The print product 1 serves to form an areal weaving pattern 6 composed of longitudinal strips 7 and transverse strips 8 which are crossed at right angles and woven. The longitudinal strips 7, which are parallel to one another, are, for example, all the same length and all the same width among one another. The longitudinal strips 7 for example comprise the longitudinal strips 7.1 to 7.13.

The transverse strips 8, which are parallel to one another, are, for example, all the same length and all the same width among one another. The transverse strips 8, for example, comprise the transverse strips 8.1 to 8.17.

A Cartesian coordinate system is used as a basis to define the strip arrangement of the longitudinal strips 7 and the transverse strips 8.

The Cartesian coordinate system comprises a first coordinate direction and a second coordinate direction. The first coordinate direction and the second coordinate direction are at right angles to one another.

The coordinate system comprises, for example, a longitudinal direction L and, for example, a transverse direction Q, L and Q being at right angles to one another.

The longitudinal strips 7 are oriented in the first coordinate direction L and the transverse strips 8 are oriented in the second coordinate direction Q. The longitudinal strips 7 and the transverse strips 8 can be created, from the print product 4 and 5, respectively, as printed carrier materials strips which are separated from one another in the strip longitudinal direction.

For example, in the case of common paper carrier materials and image formats, for example, in DIN A4 or DIN A3 format, a width b of the first print region 4 in the second coordinate direction Q (see FIG. 1) is, for example, greater than the width of the original image motif or the image motif used as the basis by values of between 0.1 to 0.5 millimeters. From an image center BM, the additional width is identical up to the respective end point of the width of the first print region 4. The width b of the first print region 4 is electronically generated. In this way, electronic image distortion is realized.

For example, in the case of common paper carrier materials and image formats, for example, in DIN A4 or DIN A3 format, a length 1 of the first print region 4 in the first coordinate direction L is, for example, greater than the length of the original image motif or the image motif used as the basis by values of 0.5 millimeters. Thus, for example, wrap-around paths in the subsequent weaving pattern are or can be compensated for. The length 1 of the first print region 4 is electronically generated. In this way, electronic image distortion is realized.

For example, in the case of common paper carrier materials and image formats, for example, in DIN A4 or DIN A3 format, a width b1 of the second print region 5 in the second coordinate direction Q is, for example, greater than the width of the original image motif or the image motif used as the basis by values of between 0.1 to 1.5 millimeters. The value of the difference in the width compared with the original image motif is, for example, dependent on an overall width of the image motif and/or the paper strength and/or the bending strength of the paper. Thus, for example, differences in wrap-around paths are or can be compensated for.

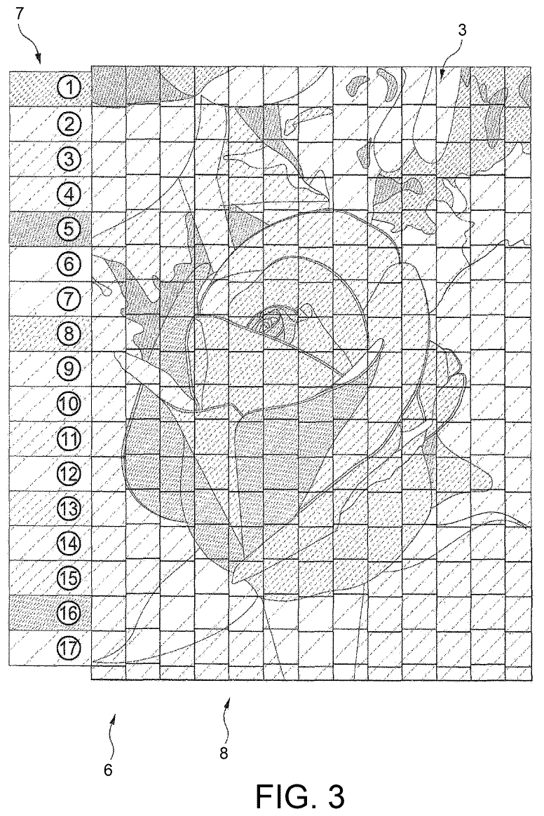

A visible side, illustrated in FIG. 3, of the finished woven weaving pattern 6 is visible to a person a depiction of the image motif 3 or as an almost identical depiction of the image motif 3 used as the basis.

The first print region 4 is used to create all the longitudinal strips 7 for the weaving pattern 6 which run in parallel in the first coordinate direction L. The second print region 5 is used to create all the transverse strips 8 for the weaving pattern 6 which run in parallel in the second coordinate direction Q.

For the printing of the first print region 4 and the second print region 5, the image motif 3 is divided into a multiplicity of quadrilateral image sections 9, which are reproduced in printed form on the longitudinal strips 7 and on the transverse strips 8.

For example, in FIG. 1 and FIG. 2, three singled-out image sections 9 are each denoted by a reference sign.

The first print region 4 serves to provide all the longitudinal strips 7, the longitudinal axis of which runs in the first coordinate direction L, wherein account is always taken of an identical distance a on the longitudinal strip 7 in the first coordinate direction L between two adjacent image sections 9 on the longitudinal strip 7, the distance a being dependent on the material thickness of the carrier material 2.

The print regions 4, 5 are created in such a way that the overall image motif 3 in the finished weaving pattern 6 is divided into the multiplicity of quadrilateral image sections 9. The image sections 9 have two parallel outer sides which are parallel to the first coordinate direction L. The image sections 9 have two further parallel outer sides which are parallel to the second coordinate direction.

Mutually facing longitudinal edges of two adjacent longitudinal strips 7 are formed adjoining one another in the first print region 4.

Between two adjacent transverse strips 8, between mutually facing longitudinal edges of the two adjacent transverse strips 8, an intermediate strip 12 formed by the carrier material of the second print region is formed over the length of the two transverse strips 8.

A region on a longitudinal strip or on a transverse strip, the region not being reproduced on the visible side of the weaving pattern, is, for example, only partially printed. For example, a central subregion of this region is not printed or is, for example, printed in a single color, for example, white.

For example, the longitudinal strips are separated from one another in relation to mutually adjoining parallel longitudinal edges, for example, by a cut through the carrier material.

Information is, for example, printed outside the region of the longitudinal strip and/or outside the region of the transverse strip. For example, strip-like extensions 10 are on the first print region 4 and strip-like extensions 11 are on the second print region 5, with consecutive numbering of the transverse strips 8 with numerals “1” to “17”.

### LIST OF REFERENCE SIGNS

1 Print product
2 Carrier material
3 Image motif
4 Print region
5 Print region
6 Weaving pattern
7 Longitudinal strip
7.1-7.13 Longitudinal strip
8 Transverse strip
8.1-8.17 Transverse strip
9 Image section
10 Extension
11 Extension
12 Intermediate strip

1. A method for producing a print product by a printing method, wherein the print product comprises a thin carrier material, wherein a thickness of the carrier material, said thickness generally being uniform over an areal extent of the carrier material, is up to two millimeters, wherein use is made of an electronically provided print file which provides data relating to an image motif, wherein the print file is used to print two print regions on the carrier material, which differ from one another, wherein the two print regions are each formed from the data relating to the image motif and each print region at least partially reproduces the image motif, wherein the print product is produced in such a way that the print product serves to form an areal weaving pattern composed of longitudinal strips and transverse strips which are crossed at right angles and woven, wherein a Cartesian coordinate system having a first coordinate direction, which is a longitudinal direction, and having a second coordinate direction is used as a basis, wherein the first coordinate direction and the second coordinate direction are at right angles to one another, with a first coordinate direction of the longitudinal strips, which are parallel to one another, and a second coordinate direction of the transverse strips, which are parallel to one another, wherein the longitudinal strips and the transverse strips can be created, from the print product, as printed carrier material strips which are separated from one another in a strip longitudinal direction, wherein a visible side of the finished woven weaving pattern is visible to a person as a reproduction of the image motif used as the basis, wherein the first print region of the print product is produced and wherein the second print region of the print product is produced, such that all the longitudinal strips running in parallel in the first coordinate direction of the weaving pattern are created from the first print region and wherein all the transverse strips running in parallel in the second coordinate direction of the weaving pattern are created from the second print region, wherein the first print region of the print product and the second print region of the print product are designed to be coordinated with one another in such a way that, in the finished weaving pattern, the image motif is completely and correctly reproduced on the visible side of the weaving pattern, wherein the overall image motif is divided into a multiplicity of quadrilateral image sections, wherein the first print region serves to provide all the longitudinal strips, the longitudinal axis of which run in the first coordinate direction, wherein account is always taken of an identical distance on the longitudinal strip in the first coordinate direction between two adjacent image sections on the longitudinal strip, the distance being dependent on the material thickness of the carrier material.

2. The method as claimed in claim 1, wherein the distance is calculated from the thickness of the carrier material multiplied by a factor, the factor assuming values of between 5.5 and 8.5.

3. The method as claimed in claim 1, wherein the print regions are created in such a way that the overall image motif in the finished weaving pattern is divided into a multiplicity of quadrilateral image sections, wherein outer sides of the image sections run parallel to the second coordinate direction and further outer sides of the image sections run parallel to the first coordinate direction.

4. The method as claimed in claim 1, wherein all the image sections of the image motif which together produce the image motif are formed by the entirety of all the image sections which are visible in the weaving pattern on the longitudinal strips together with all the image sections which are visible in the weaving pattern on the transverse strips.

5. The method as claimed in claim 1, wherein mutually facing longitudinal edges of two adjacent longitudinal strips are formed adjoining one another.

6. The method as claimed in claim 1, wherein an intermediate strip formed by the carrier material of the second print region is formed between two transverse strips in the first coordinate direction.

7. The method as claimed in claim 1, wherein a region on a longitudinal strip or a region on a transverse strip, the region not being reproduced on the visible side of the weaving pattern, is not printed or is at least partially not printed or is not printed according to the image motif.

8. A print product composed of a printed carrier material, wherein the print product is produced by a digital printing method on the basis of data relating to an image motif, wherein a thickness of the carrier material, said thickness generally being uniform over an areal extent of the carrier material, is up to two millimeters, wherein the print product has two print regions on the carrier material, which differ from one another, wherein the two print regions are each formed from the data relating to the image motif and each print region at least partially reproduces the image motif, wherein the print product serves to form an areal weaving pattern composed of longitudinal strips and transverse strips which are crossed at right angles and woven, with a first coordinate direction of the longitudinal strips, which are parallel to one another, and a second coordinate direction of the transverse strips, which are parallel to one another, wherein the longitudinal strips and the transverse strips can be created, from the print product, as printed carrier material strips which are separated from one another in the strip longitudinal direction, wherein a visible side of the finished woven weaving pattern is visible to a person as a reproduction of the image motif used as the basis, wherein all the longitudinal strips running in parallel in the first coordinate direction of the weaving pattern are created from the first print region and wherein all the transverse strips running in parallel in the second coordinate direction of the weaving pattern are created from the second print region, wherein the first print region of the print product and the second print region of the print product are designed to be coordinated with one another in such a way that, in the finished weaving pattern, the image motif is completely and correctly reproduced on the visible side of the weaving pattern, wherein the overall image motif is divided into a multiplicity of quadrilateral image sections, wherein the first print region serves to provide all the longitudinal strips, the longitudinal axis of which run in the first coordinate direction, wherein account is always taken of an identical distance on the longitudinal strip in the first coordinate direction between two adjacent image sections on the longitudinal strip, the distance being dependent on the material thickness of the carrier material.

9. The print product as claimed in claim 8, wherein the print product has a first printed print region and a second printed print region on the carrier material, which differ from one another, wherein the two print regions are based on a common image motif, wherein longitudinal strips composed of the carrier material can be provided from the first print region and wherein transverse strips composed of the carrier material can be provided from the second print region, such that an areal weaving pattern composed of longitudinal strips and transverse strips which are crossed at right angles and woven can be formed from the longitudinal strips and from the transverse strips of the print product, wherein, in the finished weaving pattern, the image motif is completely and correctly reproduced on the visible side of the weaving pattern.

10. The print product as claimed in claim 8, wherein the longitudinal strips have opposite parallel longitudinal edges which are separated from adjoining regions of the print product.

11. The print product as claimed in claim 8, wherein the transverse strips have opposite parallel longitudinal edges which are separated from adjoining regions of the print product.

12. The print product as claimed in claim 8, wherein an end-side end of the longitudinal strip is connected to a region of the print product that adjoins a longitudinal strip.

13. The print product as claimed in claim 8, wherein an end-side end of the transverse strip is connected to a region of the print product that adjoins a transverse strip.

14. The print product as claimed in claim 8, wherein, in the extension of an end-side end of a longitudinal strip and/or in the extension of an end-side end of a transverse strip, a marking is present which enables visual identifiable assignment of the respective strip with respect to its position in the first coordinate direction and/or second coordinate direction.

15. The print product as claimed in claim 8, wherein information is printed outside the region of the longitudinal strip and/or outside the region of the transverse strip.

16. A weaving pattern composed of strips of a carrier material, wherein a thickness of the carrier material, said thickness generally being uniform over an areal extent of the carrier material, is up to two millimeters, wherein the areal weaving pattern is formed from longitudinal strips and transverse strips which are crossed at right angles and woven, with a first coordinate direction of the longitudinal strips, which are parallel to one another, and a second coordinate direction of the transverse strips, which are parallel to one another, wherein the longitudinal strips and the transverse strips are created, from a print product, as printed carrier material strips which are separated from one another in the strip longitudinal direction, wherein a visible side of the finished woven weaving pattern is visible to a person as a reproduction of an image motif used as the basis, wherein the print product has a first print region from which all the longitudinal strips running in parallel in the first coordinate direction of the weaving pattern can be created and wherein the print product has a second print region from which all the transverse strips running in parallel in the second coordinate direction of the weaving pattern can be created, wherein the first print region of the print product and the second print region of the print product are designed to be coordinated with one another in such a way that, in the finished weaving pattern, the image motif is completely and correctly reproduced on the visible side of the weaving pattern, wherein the overall image motif is divided into a multiplicity of quadrilateral image sections, wherein the first print region serves to provide all the longitudinal strips, the longitudinal axis of which run in the first coordinate direction, wherein account is always taken of an identical distance on the longitudinal strip in the first coordinate direction between two adjacent image sections on the longitudinal strip, the distance being dependent on the material thickness of the carrier material.

17. The weaving pattern as claimed in claim 16, wherein a frame-like border of the weaving pattern is provided, said border adjoining longitudinal ends of the longitudinal strips and longitudinal ends of the transverse strips.
